(19) United States
(12) Patent Application Publication
(10) Pub. No.: US 2010/0018686 A1
(43) Pub. Date: Jan. 28, 2010

(54) Method of producing a wall, particularly a wall of a micro heat exchanger, and micro heat exchanger comprising, in particular, nanotubes

(76) Inventors: Andre Bontemps, Moirans (FR); Frederic Ayela, Grenoble (FR); Alain Marechal, Tullins (FR); Thierry Fournier, Saint Ismier (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/919,536

(22) PCT Filed: Apr. 19, 2006
(86) PCT No.: PCT/FR2006/000862

§ 371 Date: Aug. 19, 2009

(30) Foreign Application Priority Data
Apr. 29, 2005 (FR) 0504340

(51) Int. Cl. F28F 13/18; B05D 3/00

(52) U.S. Cl. 165/133; 427/271

(57) ABSTRACT

Method of producing a wall, in particular a micro heat exchanger for semiconductor devices or microsystems, and micro heat exchanger, in which particles are embedded in a layer, some of which have a part anchored into a wall of said layer and a part projecting from this wall after removal of material.

### BACKGROUND OF THE INVENTION

1. Field of the Invention

The present invention relates to the field of semiconductor devices or Microsystems.

2. Description of the Relevant Art

The increase in performance and increasing reduction in the dimensions of components of such devices are systems are increasingly causing problems associated with heat generation.

In general, the solution proposed for removing the heat generated consists of the use of fans installed near devices and systems for the purpose of overall cooling them.

It appears to be advantageous to design micro heat exchangers suitable for removing the heat generated locally in such devices and systems by creating micro channels for the flow of heat transfer fluids. However, the quantities of heat removed depend in particular on the area of contact between the material and the fluid.

### SUMMARY OF THE INVENTION

In one embodiment, a method of producing a wall, in particular a micro heat exchanger for semiconductor devices or Microsystems is described.

According to an embodiment, this method includes: choosing a matrix material capable of passing from a nonsolid state to a cured state under the effect of a change-of-state treatment and, in this cured state, of being degraded under the effect of a degradation treatment; and choosing particles made of a material substantially insensitive to said change-of-state treatment and to said degradation treatment.

The method according to an embodiment includes: mixing a quantity of particles with a quantity of matrix material in the nonsolid state; depositing this mixture, at least partly, on one surface of a substrate; applying said change-of-state treatment to the deposited mixture so that it passes into its cured state; applying said degradation treatment to part of the volume of the cured deposited mixture and removing this volume part or the complementary volume part.

According to an embodiment, the wall of the remaining volume part of the cured deposited mixture, corresponding to the interface between the remaining volume part and the removed volume part, is advantageously provided with particles that are partly anchored into this remaining volume part and constituting asperities.

According to an embodiment, said mixture is obtained by mixing or stirring.

According to an embodiment, said matrix material is a photosensitive thermosetting resin or photoresist.

According to an embodiment, said particles are nanotubes.

According to an embodiment, this method includes: depositing a layer of the mixture on one surface of a substrate; applying said change-of-state treatment to this layer so that it passes to its cured state; applying said degradation treatment to at least one region of this cured layer; and removing the volume of this region or the complementary region.

According to an embodiment, the method may include applying said degradation treatment down to the surface of said substrate.

According to an embodiment, the method may include applying said degradation treatment to a surface part of said layer.

An embodiment is also directed to a micro heat exchanger.

According to an embodiment, a micro heat exchanger may include a substrate to be at least locally cooled, a layer formed on at least one part of one surface of the substrate and particles embedded in said layer, some of which have a part anchored into a wall of said layer and a part projecting from this wall.

According to an embodiment, a micro heat exchanger may include a substrate to be at least locally cooled, a layer formed on at least one part of one surface of the substrate and having at least one trench, at least one cover covering said trench, so as to constitute at least one channel, and particles embedded in said layer, some of which have parts anchored into the wall of this channel and parts projecting into this channel.

### BRIEF DESCRIPTION OF THE DRAWINGS

Particular embodiments of the present invention will now be described by way of nonlimiting examples and illustrated by the drawing, in which:

FIG. 1 shows a cross section through a first semiconductor device or microsystem;

FIG. 2 shows an enlarged local cross section of the device of FIG. 1;

FIGS. 3-7 show steps in the fabrication of the device of FIG. 1; and

FIG. 8 shows a cross section through a second semiconductor device or microsystem.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

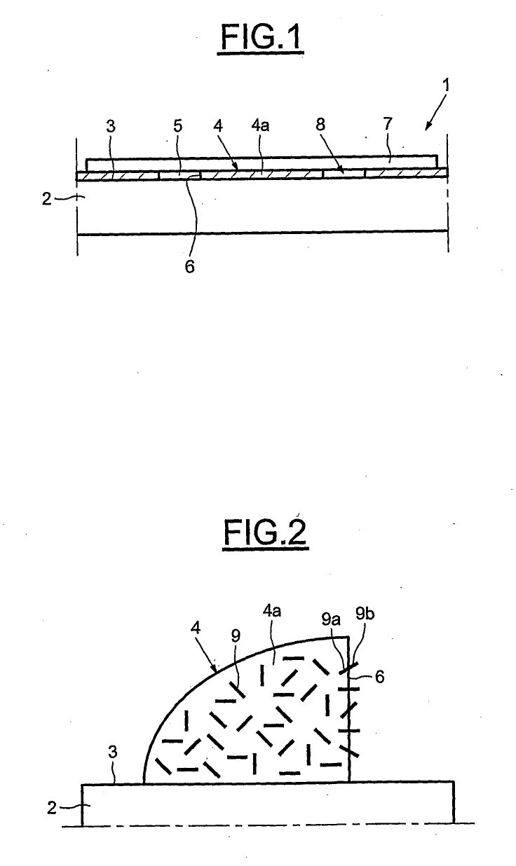

Referring to FIG. 1, it may be seen that this shows a semiconductor device or microsystem 1 including a support consisting for example of a substrate 2 incorporating electronic and/or optical or other components.

Formed on a face 3 of this substrate 2 is a layer 4 in which a trench 5 having sidewalls 6 perpendicular to the face 3 is provided, or several trenches are formed therein, in such a way that the layer 4 has regions 4a covering the substrate 2.

The trench 5 is covered by an attached cover 7 fastened to the outer face of the layer 4 so as to convert this trench 5 into a channel 8. In the case of several trenches, one or more covers may be provided.

By making a suitable fluid flow in the channel 8, by any appropriate means, it is then possible to remove the heat generated in the substrate 2, in the vicinity of this channel, directly via its surface exposed in the trench 5 and indirectly via the layer 4 by the sidewalls 6.

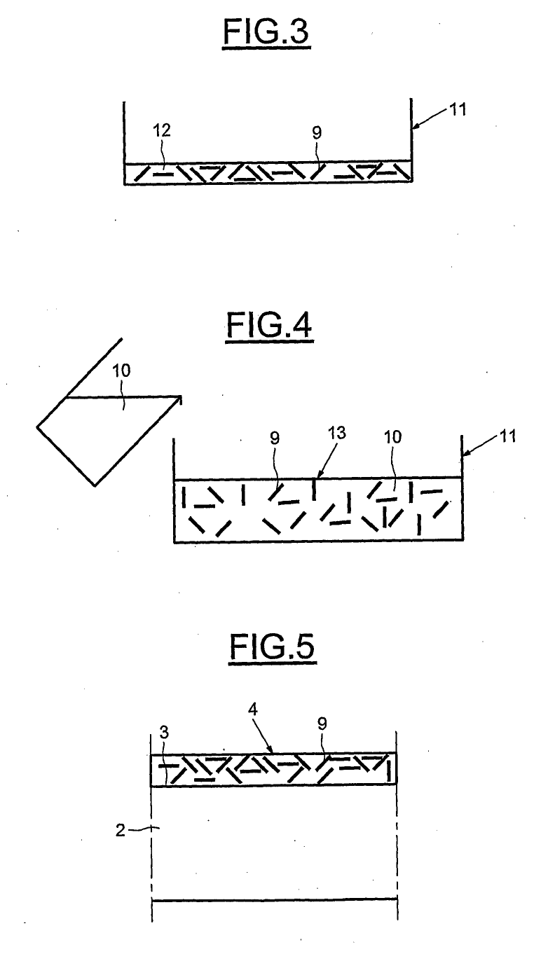

Referring to FIG. 2, it may be seen that particles 9, substantially distributed, are embedded in the constituent material of the layer 4 and that the walls 6 are provided with some of these particles, such that they have parts 9a anchored into the constituent material of the layer 4 and exposed parts 9b projecting from these walls.

The parts 9a of the particles 9 constitute asperities forming extensions of the surfaces of the walls 6 and contribute to better heat transfer between the layer 4 and the fluid flowing in the channel 8.

It follows from the foregoing that the layer 4 provided with the cover 7 constitutes a micro heat exchanger attached to the substrate 2.

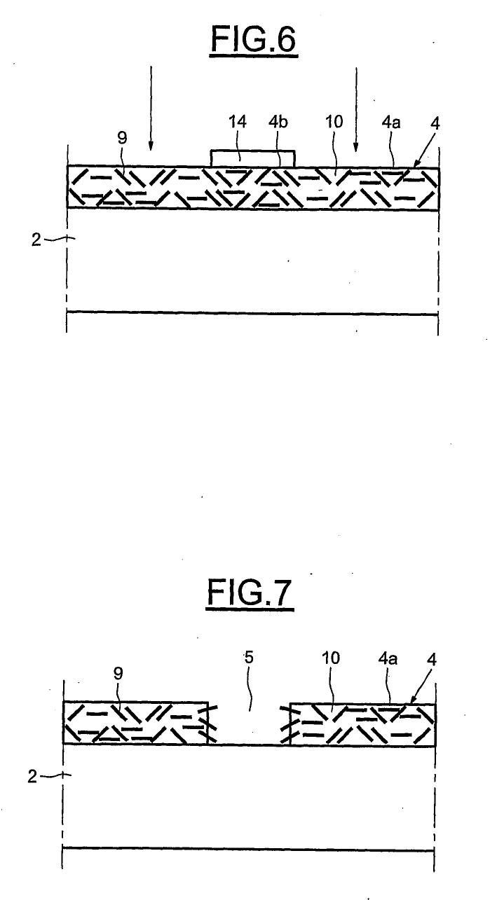

One embodiment of the device 1 will now be described, with reference to FIGS. 3 to 7, by implementing the means widely used in the field of microelectronics.

For the purpose of forming the layer 4, a matrix material is chosen that is capable of passing from a nonsolid state to a cured state under the effect of a change-of-state treatment and, in this cured state, of being degraded under the effect of a degradation treatment. Advantageously, this matrix material may be a photoresist 10. For example, an SU8 negative resist may be chosen.

With a view to forming the particles 9, nanoparticles are chosen, for example carbon nanotubes, substantially insensitive to said change-of-state treatment and to said degradation treatment.

In a first step shown in FIG. 3, a quantity of nanotubes 9 are dispersed in a liquid or solvent 12 in a container 11, said liquid or solvent being physically and chemically inert with respect to these nanotubes 9 and to the resist 10.

This step is carried out by mechanical or ultrasonic stirring using any known means.

In a second step shown in FIG. 4, a quantity of resist 10 in the nonsolid state is gradually added.

This step is carried out while providing mechanical stirring by any known means.

A mixture 13 is therefore obtained in which the nanotubes 9 are preferably distributed homogeneously within the resist 10 in the nonsolid state.

In a third step shown in FIG. 5, the mixture 13 is spread onto the face 3 of the substrate 2, for example using centrifugal force, so as to obtain a substantially uniform layer 4 in which the nanotubes 9 are substantially distributed and oriented randomly.

Next, the layer 4 is subjected to a curing operation by an appropriate heat treatment.

In a fourth step shown in FIGS. 6 and 7, the part 4a of the layer 4 is locally irradiated through a mask 14, in the regions not corresponding to the trench 5 to be produced. Next, the volume of the part 4b of the layer 4 corresponding to the trench 5 is removed, for example by immersion in a chemical developer, forming the regions 4a of the remaining volume of the layer 4 and the trench 5. In the case in which the matrix material is a positive resist, the reverse procedure is carried out.

Since the nanotubes 9 are insensitive to the above irradiation and chemical development treatments, the walls 6 of the remaining part 4a of the layer 4 remain provided, as indicated above, with randomly oriented nanotubes 9, these nanotubes 9 having parts 9a anchored into the material constituting this layer and exposed parts 9b projecting from these walls 6.

The cover 7 can then be installed.

As an example, the layer 4 could have a thickness of about 200 microns and the trench 5 could have a width ranging from about a few microns to a few millimeters. The nanotubes could have a length of about a few microns and a diameter of about a few nanometers.

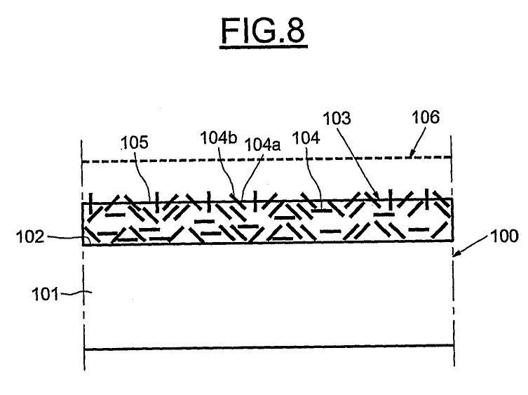

Referring to FIG. 8, this shows another semiconductor device or microsystem 100 including a support consisting for example of a substrate 101 incorporating electronic and/or optical or other components.

Formed on one face 102 of the substrate 101 is a layer 103, for example made of a resin, in which microparticles, for example carbon nanotubes 104, are embedded.

The wall 105 of the layer 103, formed by its opposed outer face parallel to the face 102 of the substrate 101, is provided with certain nanotubes 104, which, as in the previous example, have parts anchored into the layer 103 and parts projecting from the wall 105, which constitute asperities forming extensions of this wall.

The heat generated in the substrate 101 can then be removed through the layer 103, which could be locally produced on regions of this substrate and which constitutes a heat exchanger.

To produce the device 100, the means widely known in the microelectronics field may also be employed.

For example, a mixture 13 is spread over the face 102 of the substrate 101 in order to form a layer 106 thicker than the layer 103 to be obtained. This layer 106 is then irradiated down to a depth corresponding to the surface 105 of the layer 103 to be obtained. Finally, the volume of the surface part of the layer 106 is removed so that only the remaining volume of the layer 103 is left.

The present invention is not limited to the examples described above. The materials used for the matrix material and the added microparticles may be chosen differently. The shape of the mixture deposited on a substrate may be adapted to the desired heat exchange.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of producing a wall, in particular a micro heat exchanger for semiconductor devices or microsystems, comprising:
choosing a matrix material capable of passing from a nonsolid state to a cured state under the effect of a change-of-state treatment and, in this cured state, of being degraded under the effect of a degradation treatment;
choosing particles made of a material substantially insensitive to said change-of-state treatment and to said degradation treatment;
mixing a quantity of particles with a quantity of matrix material in the nonsolid state;
depositing this mixture, at least partly, on one surface of a substrate;
applying said change-of-state treatment to the deposited mixture so that it passes into its cured state; and
applying said degradation treatment to part of the volume of the cured deposited mixture and
removing this volume part or the complementary volume part, in such a way that the wall of the remaining volume part of the cured deposited mixture, corresponding to the interface between the remaining volume part and the removed volume part, is provided with particles that are partly anchored into this remaining volume part and constituting asperities.

2. The method as claimed in claim 1, wherein said mixture is obtained by mixing or stirring.

3. The method as claimed in claim 1, wherein said matrix material is a photosensitive thermosetting resin or photoresist.

4. The method as claimed in claim 1, wherein said particles are carbon nanotubes.

5. The method as claimed in claim 1 further comprising:
depositing a layer of the mixture on one surface of a substrate;
applying said change-of-state treatment to this layer so that it passes to its cured state;
applying said degradation treatment to at least one region of this cured layer; and
removing the volume of this region or the complementary region.

6. The method as claimed in claim 5, further comprising applying said degradation treatment down to the surface of said substrate.

7. The method as claimed in claim 5, further comprising applying said degradation treatment to a surface part of said layer.

8. A micro heat exchanger, comprising a substrate to be at least locally cooled, a layer formed on at least one part of one surface of the substrate, and particles embedded in said layer, some of which have a part anchored into a wall of said layer and a part projecting from this wall, said layer provided with particles being obtained by implementing the method according to claim 1.

9. A micro heat exchanger, comprising a substrate to be at least locally cooled, a layer formed on at least one part of one surface of the substrate and having at least one trench, at least one cover covering said trench, so as to constitute at least one channel, and particles embedded in said layer, some of which have parts anchored into the wall of this channel and parts projecting into this channel, said layer provided with particles being obtained by implementing the method as claimed in claim 1.

10. The micro heat exchanger as claimed in claim 8, wherein said layer comprises a matrix material made of a photoresist and said particles are nanotubes.

11. The micro heat exchanger as claimed in claim 9, wherein said layer comprises a matrix material made of a photoresist and said particles are nanotubes.
